(19) United States
(12) Patent Application Publication
(10) Pub. No.: US 2006/0204813 A1
(43) Pub. Date: Sep. 14, 2006

(54) IONIC CONDUCTOR, METHOD OF MANUFACTURING THE SAME, AND ELECTROCHEMICAL DEVICE

(76) Inventors: Takuro Hirakimoto, Tokyo (JP); Yong Ming Li, Tokyo (JP); Kazuaki Fukushima, Tokyo (JP)

Correspondence Address: BELL, BOYD & LLOYD, LLC, P. O. BOX 1135, CHICAGO, IL, 60690-1135, US

(21) Appl. No.: 10/565,897

(22) PCT Filed: Jul. 28, 2004
(86) PCT No.: PCT/JP04/11127

§ 371 Date: Jan. 25, 2006

(30) Foreign Application Priority Data
Jul. 28, 2003 (JP) 2003-280603
Apr. 8, 2004 (JP) 2004-114356

(51) Int. Cl. H01M 8/10; C08J 5/20

(52) U.S. Cl. 429/33; 521/25

(57) ABSTRACT

An ionic conductor insoluble to water and fuel, and capable of stably allowing ions such as protons to conduct therethrough, a method of manufacturing the same, and an electrochemical device. The ionic conductor having a derivative in which an ion-dissociative group is bound to a carbonaceous substance composed of at least one species selected from the group consisting of fullerene molecule, cluster mainly composed of carbon, and structure of linear or tubular carbon; and a polymer of a substance having a basic group. A method of manufacturing an ionic conductor having a step of dissolving the above-described derivative; and a polymer of the substance having the basic group; into a solvent to thereby prepare a homogeneous solution; and a step of removing the solvent. An electrochemical device having a negative electrode, a positive electrode, and an ionic conductor held therebetween, wherein the ionic conductor is composed of the ionic conductor of the present invention described in the above.

### FIELD OF THE INVENTION

The present invention relates to an ionic conductor, a method of manufacturing the same, and an electrochemical device.

### DESCRIPTION OF RELATED ART

Fuel cell has attracted a good deal of attention as an environment-conscious electric energy generation apparatus for the next generation, by virtue of its high efficiency and cleanliness, and has extensively been developed in various fields.

The fuel cell per se can roughly be classified based on types of proton conductor used therein, because temperature and conditions of use strongly affect properties of the proton conductor. Because properties of the proton conductor to be used affect the fuel cell performance so strongly as described above, improvement in the proton conductor performance holds a critical key for improvement in the fuel cell performance.

There is reported an investigation into use, as the proton conductor, a compound having a basic polymer and an acid molecule combined therein (see Prog. Polym. Sci., 2000, 1463-1502, for example). There is another report of an exemplary case where a fullerene compound having a proton-dissociative group such as sulfate ester group (—OSO₃H) or sulfonic acid group (—SO₃H) is used as the proton conductor, which is reportedly exhibit a proton conductivity of 10⁻² S/cm.

Use of the above-described compound having a basic polymer and an acid molecule combined therein as the proton conductor, so as to configure a fuel cell, however, results in dissolution of the low-molecular-weight acid into water generated during use of the fuel cell, or into alcohols (methanol solution, for example) used as a fuel, to thereby cause lowering in the proton conduction.

Also a case where a fullerene compound, which comprises a fullerene molecule and a proton-dissociative group bound thereto, is used as the proton conductor, results in lowering in the proton conduction due to physical instability, because the fullerene compound is soluble to alcohols (methanol solution, for example) used as the fuel, and to water generated during use of the fuel cell.

The present invention is conceived aiming to solve the above-described problems, and an object thereof is to provide an ionic conductor insoluble to water and fuel, and capable of stably allowing ions, such as protons, to conduct therethrough, a method of manufacturing the same, and an electrochemical device.

### DISCLOSURE OF THE INVENTION

That is, the present invention relates to an ionic conductor which has a derivative in which an ion-dissociative group is bound to a carbonaceous substance composed of at least one species selected from the group consisting of fullerene molecule, cluster mainly composed of carbon, and structure of linear or tubular carbon; and a polymer of a substance having a basic group.

The present invention also relates to a method of manufacturing an ionic conductor which includes a step of dissolving a derivative in which an ion-dissociative group is bound to a carbonaceous substance composed of at least one species selected from the group consisting of fullerene molecule, cluster mainly composed of carbon, and structure of linear or tubular carbon; and a polymer of a substance having a basic group; into a solvent to thereby prepare a homogeneous solution; and a step of removing the solvent.

The present invention also relates to a method of manufacturing an ionic conductor which includes a step of dissolving a derivative in which an ion-dissociative group is bound to a carbonaceous substance composed of at least one species selected from the group consisting of fullerene molecule, cluster mainly composed of carbon, and structure of linear or tubular carbon; and a polymer of a substance having a basic group; into respective solvents to thereby prepare respective homogeneous solutions; and a step of mixing these homogeneous solutions and recovering an insoluble component.

The present invention also relates to a method of manufacturing an ionic conductor which includes a step of mixing a derivative in which an ion-dissociative group is bound to a carbonaceous substance composed of at least one species selected from the group consisting of fullerene molecule, cluster mainly composed of carbon, and structure of linear or tubular carbon; and a monomer of a substance having a basic group; and a step of allowing the mixture to polymerize to thereby manufacture an ionic conductor having the derivative and the polymer of the substance having the basic group.

The present invention still also relates to an electrochemical device which includes a negative electrode, a positive electrode, and an ionic conductor held therebetween, wherein the ionic conductor comprises a derivative in which an ion-dissociative group is bound to a carbonaceous substance composed of at least one species selected from the group consisting of fullerene molecule, cluster mainly composed of carbon, and structure of linear or tubular carbon; and a polymer of a substance having a basic group.

In the present invention, the above-described “ion-dissociative group” means a group from which an ion such as proton (the same will apply hereinafter) can secede by ionization. The above-described “basic group” means a group capable of promoting the ionization of the above-described ion-dissociative group, accepting the dissociated ion, and further supplying the accepted ion to the adjacent ion-dissociative group or to other basic group.

According to the ionic conductor and the method of manufacturing the same of the present invention, the ionic conductor is insoluble to water, methanol solution and so forth and physically stable, because an ion complex is formed between the derivative bound with the ion-dissociative group and the polymer of the above-described substance having the basic group. A stable conduction of ion such as proton is thus ensured.

In addition, according to the electrochemical device of the present invention, the effects similar to those described in the above can be ensured, because the ionic conductor held between the negative electrode and the positive electrode is composed of the ionic conductor of the present invention having the excellent characteristics as described in the above. It is therefore made possible to realize a device having an excellent performance, such as allowing start-up under low temperatures at around room temperature and under dryness.

### BRIEF DESCRIPTION OF THE DRAWINGS

FIG. 1 is a schematic drawing of an ionic conductor based on the present invention, according to an embodiment of the present invention;

FIGS. 2A and 2B are schematic drawings of fullerene molecules serving as a matrix of the ionic conductor of the present invention, according to the same;

FIG. 3 is a schematic drawing showing various examples of the carbon cluster serving as a matrix of the ionic conductor of the present invention, according to the same;

FIG. 4 is a schematic drawing showing other examples (partial fullerene structures) of the carbon cluster, according to the same;

FIG. 5 is a schematic drawing showing other examples (diamond structures) of the carbon cluster, according to the same;

FIG. 6 is a schematic drawing of still other examples (those having clusters coupled with each other) of the carbon cluster, according to the same;

FIGS. 7A to 7C are schematic drawings of a carbon nanotube and a carbon fiber each serving as a matrix of the ionic conductor of the present invention, according to the same;

FIG. 8 shows structural formulae of materials applicable as the polymer of the substance having the basic group, according to the same;

FIG. 9 shows structural formulae of exemplary polymers of the substance having the basic groups, according to the same;

FIG. 10 is a schematic drawing showing a mechanism of proton conduction in a fuel cell, according to the same;

FIG. 11 is a schematic sectional view showing an exemplary fuel cell, according to the same;

FIG. 12 is a schematic drawing of sulfonic acid-base fullerene derivative as the derivative used in Example 1, according to an example of the present invention;

FIG. 13 is a graph showing measured results of complex impedance of the ionic conductor based on the present invention, according to the same;

FIG. 14 is a graph showing measured results of ion conductivity of the ionic conductor based on the present invention, according to the same;

FIG. 15 is a graph showing humidity dependence of the ion conductivity of the ionic conductor based on the present invention, according to the same; and

FIG. 16 is a graph showing temperature dependence of the ion conductivity of the ionic conductor based on the present invention, according to the same.

### BEST MODES FOR CARRYING OUT THE INVENTION

The ionic conductor based on the present invention preferably has the derivative bound with the ion-dissociative group and the substance having the basic group mixed therein.

Also as described later, the ionic conductor can function as a proton conductor by adopting a proton (H⁺)-dissociative group as the ion-dissociative group.

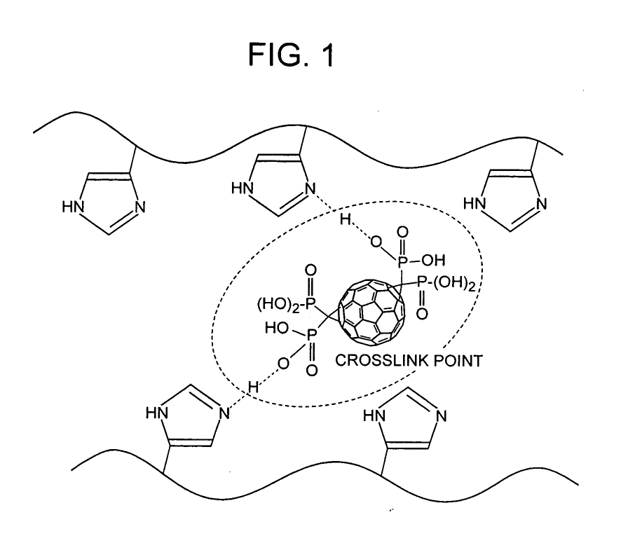

FIG. 1 is a schematic drawing of an exemplary ionic conductor based on the present invention. FIG. 1 shows an exemplary case in which the above-described fullerene molecule (C₆₀, for example) is used as the carbonaceous material, a proton-dissociative group expressed by —PO(OH)₂ is used as the ion-dissociative group, and polyvinylimidazole as a polymer of the substance having the basic group.

The ionic conductor based on the present invention is insoluble to water, methanol solution and so forth and physically stable, because an ion complex is formed between the derivative and the polymerized substance having the basic group. It is therefore made possible, if it is used as a fuel cell or the like, to realize a device having an excellent performance, such as allowing start-up under low temperatures at around room temperature and under dryness.

Herein, the ionic conductor based on the present invention may also have the carbonaceous substance bound with the ion-dissociative group and with the basic group, ensuring excellent ion conduction performance similarly to as described in the above.

At least any one species selected from the group consisting of fullerene molecule, cluster mainly composed of carbon, and structure of linear or tubular carbon is used as the carbonaceous substance which serves as the matrix, wherein it is important that the substance, after being introduced with the ion-dissociative group, shows the ion conductivity larger than the electron conductivity.

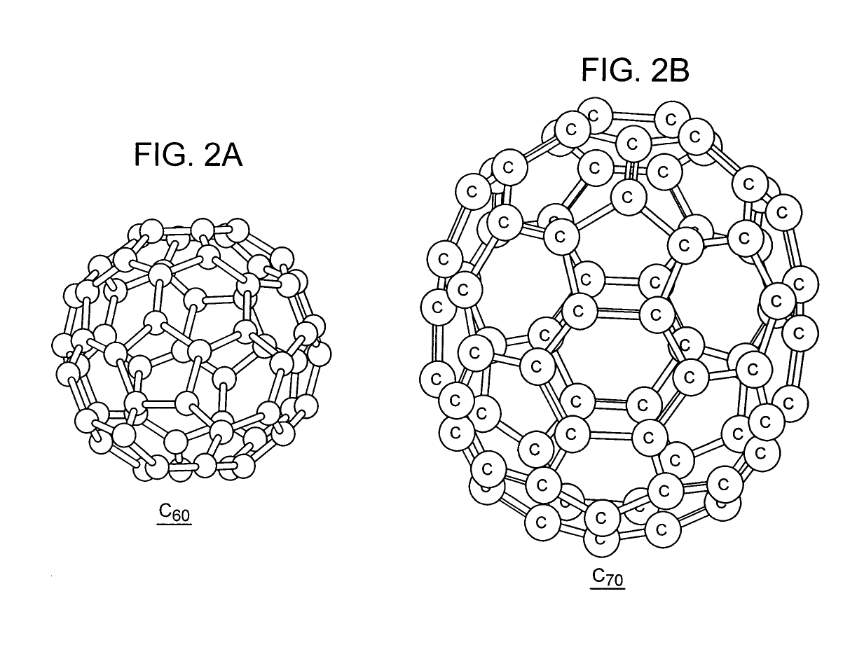

The fullerene molecule as the carbonaceous substance is not specifically limited so far as being a spherical cluster molecule, wherein it is generally preferable to use a single species, or a mixture of two or more species of fullerene molecules selected typically from C₃₆, C₆₀ (see FIG. 2A), C₇₀ (see FIG. 2B), C₇₆, C₇₈, C₈₀, C₈₂, C₈₄, C₈₆, C₈₈, C₉₀, C₉₂, C₉₄ and C₉₆.

These fullerene molecules were discovered in 1985, in a mass spectrum of a cluster beam generated by laser abrasion of carbon (Kroto, H. W.; Heath, J. R.; O'Brien, S. C.; Curl, R. F.; Smalley, R. E., Nature 1985, 318, 162). Another five years was necessary before a method of manufacturing the same was established, and fullerene has attracted a public attention typically as a carbonaceous semiconductor material, since a method of manufacturing based on the arc discharge process using carbon electrodes were found out in 1990.

For example, an aggregate of a large number of the derivatives each having therein the ion-dissociative group bound to the fullerene molecule can consecutively be used even under a dry atmosphere, because the conductivity shown in its bulk state is directly contributed by migration of ions derived from a large number of the ion-dissociative groups originally contained in the molecule.

In addition, the fullerene molecule has an electrophilic nature, and this supposedly contributes to promote release of a hydrogen ion from the proton-dissociative group as the highly acidic ion-dissociative group, ensuring excellent ion conductivity. Because a single fullerene molecule can have a considerably large number of ion-dissociative groups bound thereto, it is made possible to considerably increase the number density per unit volume of the conductor of hydrogen ions related to the conduction, and to exhibit a substantial conductivity.

The derivative composing the ionic conductor based on the present invention is configured in the most portion thereof by carbon atoms of the fullerene molecule, which is light weight, less likely to be denatured, and free from contaminants. Cost for manufacturing the fullerene molecule has rapidly been lowered. From viewpoints of natural resources, environment and economy, the fullerene molecule is supposed to be a near-ideal carbonaceous material superior to any other materials.

In the present invention, it is also allowable to use a cluster derivative in place of the derivative having the fullerene matrix, wherein the cluster derivative comprises a cluster composed of carbon powder, obtained by the ark discharge process using carbonaceous electrodes, and the ion-dissociative group bound to the carbon powder.

The cluster described herein generally refers to an aggregate of several to several hundreds of atoms coagulated with each other, and the agglomerate (aggregate) improves the ion conductivity, ensures a sufficient film strength while keeping the chemical properties, and facilitates formation of the film. The cluster also refers to an aggregate mainly composed of carbon, in which several to several hundreds of carbon atoms are bound to each other with carbon-carbon bonds of which types not specifically limited. It is, however, not always necessary for the cluster to be 100% pure carbon, and inclusion of other atoms may be possible. It is therefore defined that any aggregates in which carbon atoms accounts a large part thereof, including the above-described case, will be referred to as a carbon cluster hereinafter.

The ionic conductor based on the present invention is mainly composed of the carbon cluster as the matrix and the ion-dissociative group bound thereto, so that it can readily release the ions even under dryness, and makes it possible to exhibit effects, including ion conductivity, similar to those of an ionic conductor composed of the above-described fullerene derivatives. Another effect is also expected in that category of the carbon cluster includes a number of species of carbonaceous materials, and allows a wide range of choice of carbonaceous source materials.

The reason why the carbon cluster is used herein as the matrix is that bonding of a large amount of ion-dissociative groups is necessary in order to impart excellent ion conductivity, and the carbon cluster makes it possible. This may, on the other hand, considerably increases the acidicity of the solid-state ionic conductor, but the carbon cluster is less likely to cause oxidative degradation unlike the other general carbonaceous materials, excellent in the durability, and dense in the bonding of the constituent atoms, so that the cluster does not cause collapse of the inter-atomic bonds even under a larger acidicity (i.e., less causative of chemical modification), and can keep the film structure.

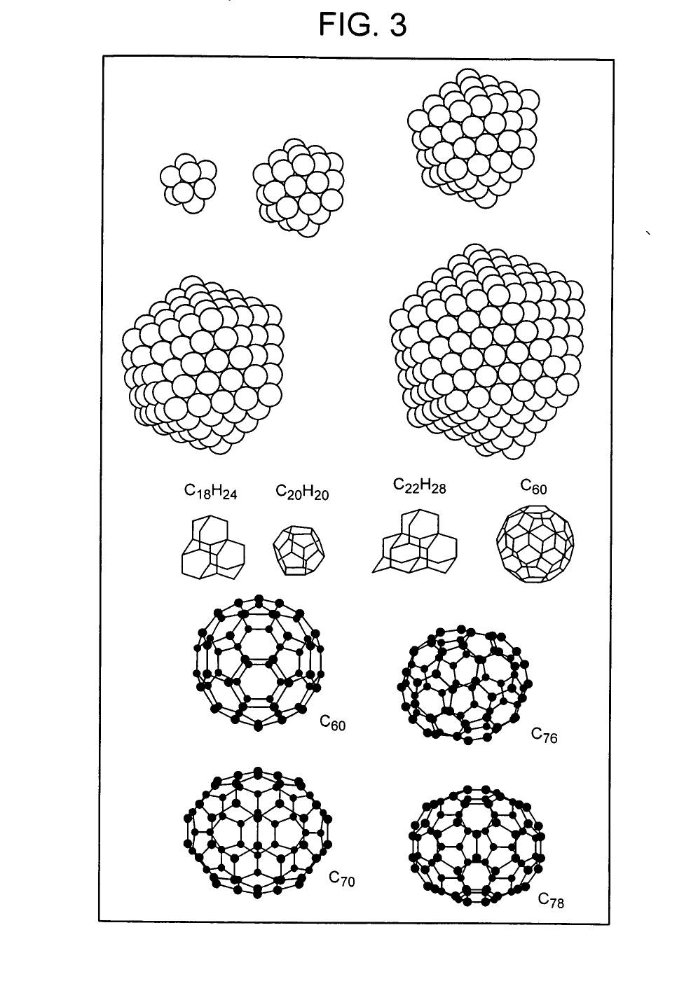

Also thus-configured ionic conductor can exhibit excellent ion conductivity even under dryness, has a variety of species as shown in FIGS. 3 to 6, and allows a wide range of material choice for the ionic conductor.

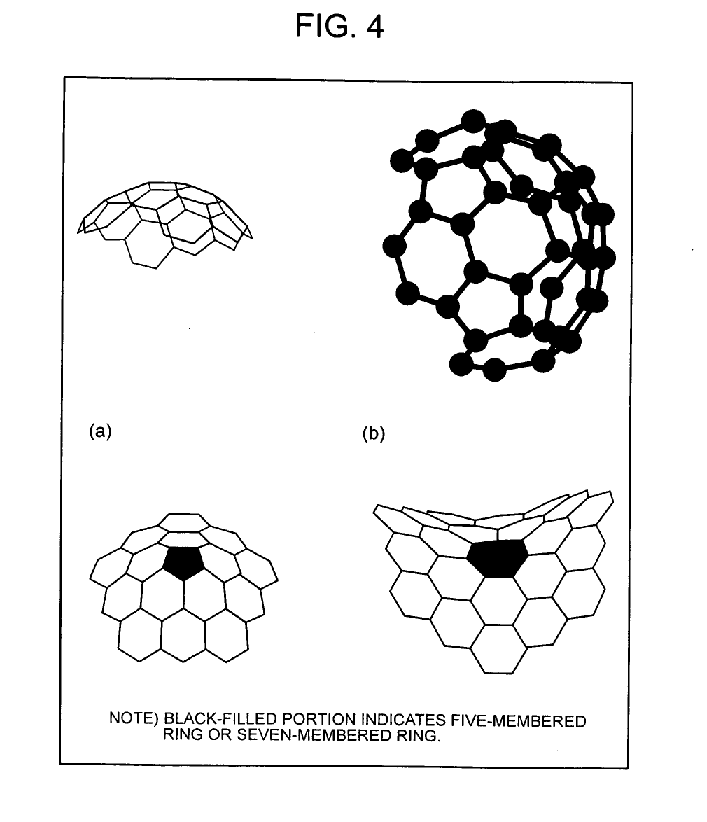

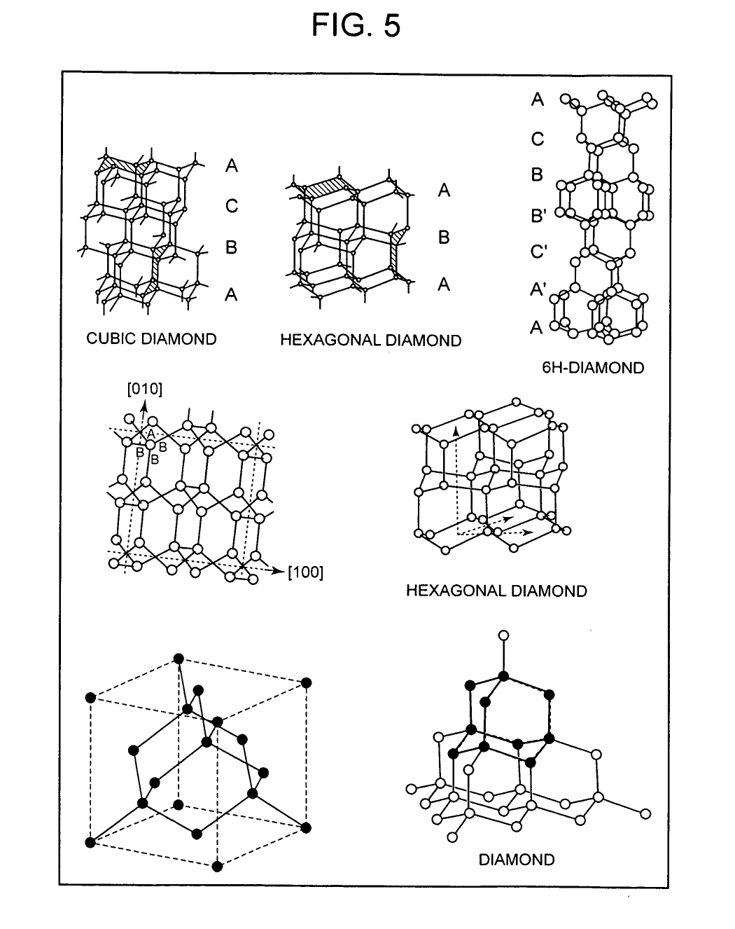

Those shown in FIG. 3 are various carbon clusters composed of aggregation of a large number of carbon atoms, and has spherical, spheroidal, or other similar closed surface structures (molecular-state fullerene also shown together). In contrast to them, the carbon clusters having a part of the spherical structures omitted therefrom are shown in FIG. 4. They are characterized in having open ends in the structures, and such structures are often found in abundance as byproducts in manufacturing process of fullerene based on arc discharge. Any carbon clusters in which most part of carbon atoms are sp3-bonded will be given as various clusters having diamond structures as shown in FIG. 5.

Any clusters in which most part of carbon atoms are sp2-bonded will have planar structure of graphite, or the entire portion or a part of structure of fullerene or nanotube. Of these, the clusters having the graphite structure often shows electron conductivity, and are not suitable as the matrix of the ionic conductor.

In contrast to this, fullerene and nanotube are preferable as the matrix of the ionic conductor, because the sp2 bonds thereof partially contain elements of the sp3 bond, so that most of them do not show electron conductivity.

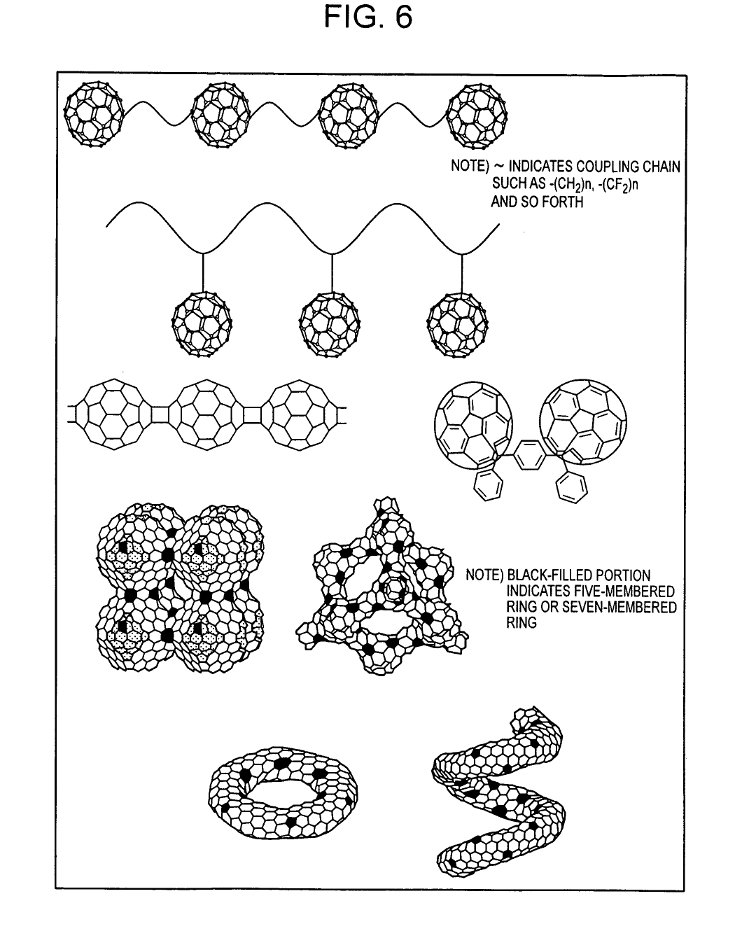

The derivative may also be composed of chemically or physically coupled product or crosslinked product of the carbonaceous substances. For example, FIG. 6 shows various examples of the clusters bound to each other, wherein all of these structures are applicable to the present invention.

The carbon cluster derivative can directly be press-formed, without using any binder, into forms of film, pellet and so forth. In the present invention, the carbon cluster as a matrix preferably has a long axis of 100 nm or shorter, more preferably 100 angstroms or shorter, and preferably has 2 or more groups to be introduced thereinto.

The carbon cluster further preferably has a basket structure (such as fullerene molecule) or has an open end at least in a portion thereof. Such defect-structured fullerene not only has a reactivity of the fullerene molecule, but also has a larger reactivity at the defect portion, or the open end. This consequently promotes introduction of the ion-dissociative group, ensuring a larger ratio of group introduction, and larger ion conductivity. This sort of carbon cluster can be synthesized in a larger mass as compared with the fullerene molecule, needing only a very low cost.

On the other hand, it is preferable to use a tubular or linear carbon structure as the matrix of the ionic conductor based on the present invention. The tubular carbon structure is preferably the one having a tube-like shape, for example, a carbon nanotube having a diameter of several nanometers or smaller, and typically 1 to 2 nm. In addition, the linear carbon structure is preferably the one having a fiber-like shape, for example, a carbon fiber having a diameter of typically several nanometers or longer, and of as large as 1 μm for the giant one.

The carbon nanotube or the carbon fiber can readily release electrons due to its structural advantage, and ensures an extremely large surface area, and is successful in further improving the proton propagation efficiency.

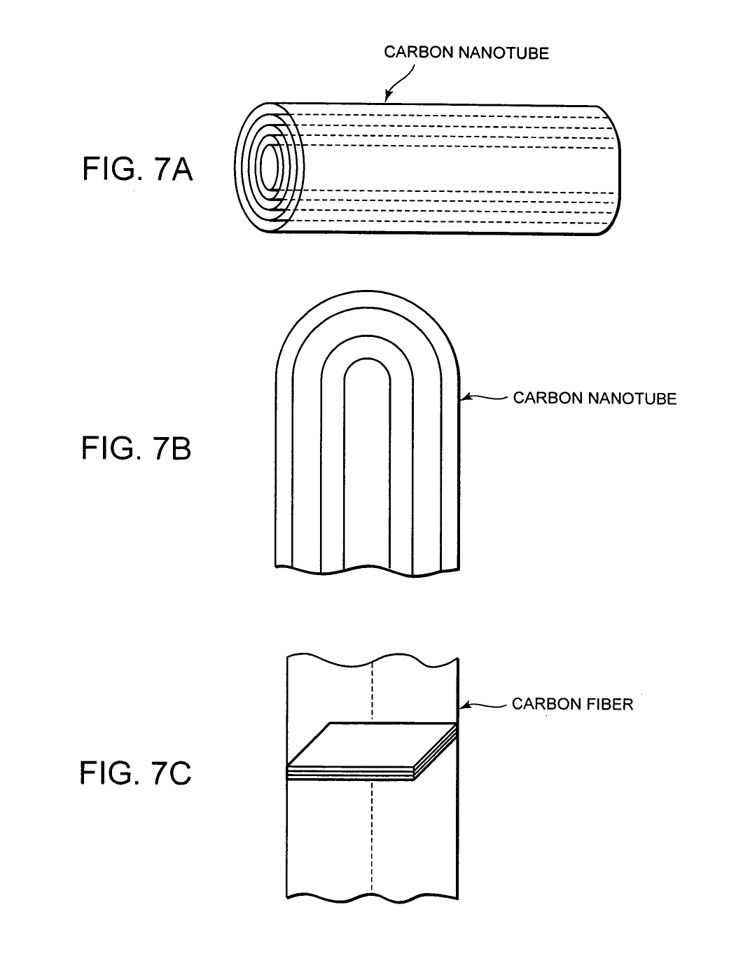

A graphene structure (cylindrical structure) of a multi-layered carbon nanotube as shown in a perspective view in FIG. 7A and a partial sectional view in FIG. 7B is a defect-free, high-quality carbon nanotube, and is known to be extremely excellent as an electron emission material. Also the carbon fiber having a structure as shown in a perspective view in FIG. 7C is preferably applicable to the present invention.

The carbon nanotube or the carbon fiber preferably applicable herein can be manufactured by the arc discharge process or the chemical vapor deposition process (thermal CVD process).

On the other hand, in the ionic conductor based on the present invention, the ion-dissociative group is preferably at least any one species selected from the group consisting of —SO₃M, —PO(OM)₂, —SO₂NMSO₂—, —SO₂NM₂, —COOM, ═CPO(OM)₂ and ═C(SO₃M)₂ (where, M represents a cation-producing group, such as active hydrogen group).

In the ionic conductor based on the present invention, at least a functional group having the ion-dissociative group is bound to the carbonaceous substance, wherein the functional group may be at least one species selected from the group consisting of -A-SO₃M, -A-PO(OM)₂, -A-SO₂NMSO₂—R , -A-SO₂NM₂ and A-COOM [where, A represents —O—, —R—, —O—R—, —R—O—, —O—R—O— or —R—O—R′— (R and R′ are either of alkyl component and fluoroalkyl component respectively expressed by CxHy or CxFyHz (1≦x≦20, 1≦y≦40, 0≦z≦39, which may be identical to or different from each other), M represents a cation producing group (for example, active hydrogen group), and R⁰ represents —CF₃ or —CH₃)].

In addition, it is also allowable to introduce, together with the ion-dissociative group, an electron-withdrawing group such as nitro group, carbonyl group, carboxyl group, nitrile group, halogenated alkyl group, halogen atoms (fluorine, chlorine, etc.), aldehyde group, sulfone group or the like into the carbon cluster. More specifically, the electron-withdrawing group is exemplified by —NO₂, —CN, —F, —Cl, —COOR, —CHO, —COR, —CF₃, —SO₃CF₃ and so forth (where, R represents an alkyl group). Such co-existence of the electron-withdrawing group makes proton or other ions more readily be released from the ion-dissociative group, while being assisted by its electron-withdrawing effect, and thus released ions are made more readily migrate via the ion-dissociative group and the basic group.

The number of ion-dissociative group to be introduced into the carbon cluster may arbitrarily be set within a range of the number of carbon atoms composing the carbon cluster, and is preferably set to 5 or more. For an exemplary case of the fullerene molecule, the number of ion-dissociative groups is preferably half or less of the number of carbon atoms composing fullerene, in view of preserving the π electron property of fullerene and allowing an effective electron-withdrawing property to exhibit.

To introduce the ion-dissociative group into the carbon cluster, it is all enough, for example, to begin with synthesis of the carbon cluster by the arc discharge between the carbonaceous electrodes, and then to subject the carbon cluster to acid treatment (such as using sulfuric acid), or to further subject it to other treatment such as hydrolysis, or to subject it to sulfonation or phosphoric esterification. This makes it possible to readily obtain a carbon cluster derivative (carbon cluster having the above-described ion-dissociative group) as a target product.

For example, when a large number of fullerene derivatives, in which the ion-dissociative groups are introduced into fullerene as the carbon cluster, are allowed to aggregate, with regard to the ion conductivity thereof shown by the bulk or by the aggregate of the fullerene derivatives, since protons derived from a large number of ion-dissociative groups (OSO₃H groups, for example) originally contained in the molecule directly contribute to migration, so that it is no more necessary to incorporate hydrogen nor proton derived from atmospheric water vapor molecules and so forth, or it is no more necessary to supply water from the external, in particular to absorb water or the like from the atmosphere, and this relieves the fullerene derivative from any environmental limitations. Because a single fullerene molecule can have a considerably large number of ion-dissociative groups introduced therein, the number density of hydrogen ion contributive to the conduction per unit volume of the conductor becomes extremely large. This is the reason why the ionic conductor based on the present invention exhibits an efficient conductivity.

As described in the above, the carbon cluster per se having the ion-dissociative groups can realize a structure in which ions such as protons are released and readily hop among the individual sites, by virtue of its structural nature such that it intrinsically has a large spatial density of functional groups of acid, and by virtue of the electronic nature of the carbon cluster matrix (fullerene, for example), and thereby can realize the conduction of ions such as protons even under dryness.

The derivative such as the above-described fullerene derivative in its single entirety is, however, soluble to water, methanol and so forth, so that use of the derivative as the ionic conductor of fuel cells or the like may result in degradation in the proton conductivity. In contrast, the ionic conductor based on the present invention as exemplified in FIG. 1 has an ion complex formed between the derivative and the polymerized substance having the basic group, and this makes the ionic conductor insoluble to water, methanol solution and so forth, and makes it physically stable, so that it is made possible to realize a device having excellent performances when applied, for example, to fuel cells, allowing start-up under low temperatures at around room temperature and under dryness.

The polymer of the substance having the basic group is preferably a polymer of a compound containing at least any one of N atom, O atom and S atom.

The polymer of the substance contains at least any one of structural components expressed by the structural formulae below, each of which contains an atom having lone pair(s) and thereby exhibits Lewis basicity.

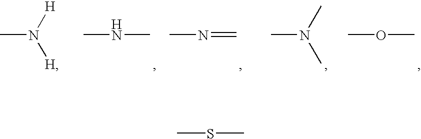

It is also preferable that the basic portion of the polymer of the substance is preferably any one species selected from the group consisting of amino group, pyrrolidone group, pyridine group, imidazole group, pyrimidine group, piperazine group, pyrrole group, pyrrolidine group, pyrazole group, benzimidazole group, phenylimidazole group and pyrazine group.

In addition, a polymer of the compound containing N atom is preferably a polymer of a heterocyclic compound.

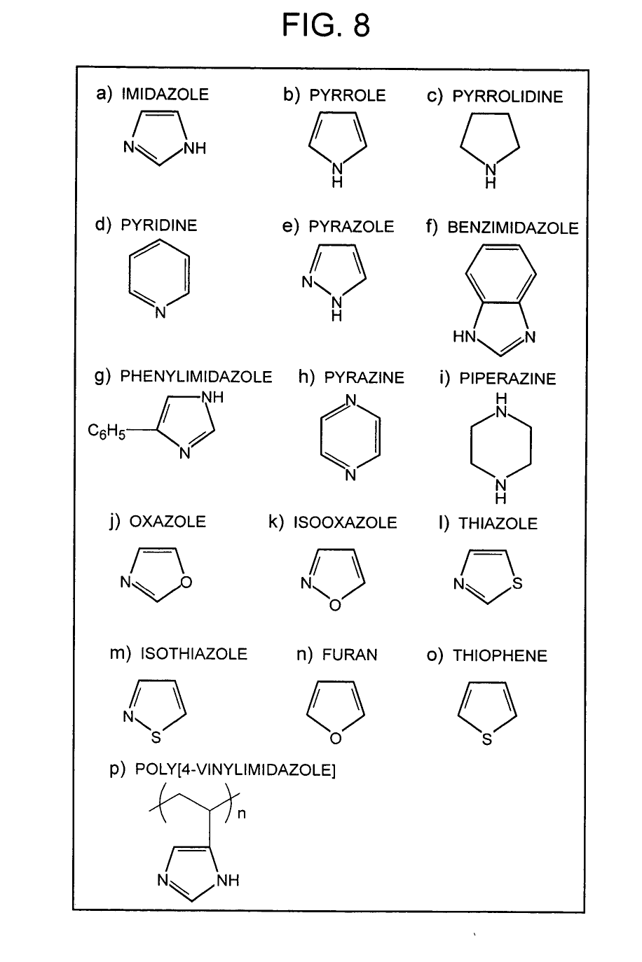

Specific examples of the polymer of the substance having the basic group include polymers having a structure of at least any one compound selected from the group consisting of imidazole, pyrrole, pyrrolidine, pyridine, pyrazole, benzimidazole, phenylimidazole, vinylimidazole, pyrazine, piperazine, oxazole, isooxazole, thiazole, isothiazole, furan and thiophene, all of which being expressed by structural formulae shown in FIG. 8, and derivatives of them. More specifically, it is preferable to use polymers such as poly[4-vinylimidazole] shown in FIG. 8(p). Needless to say, the polymer is of course not limited to those described above.

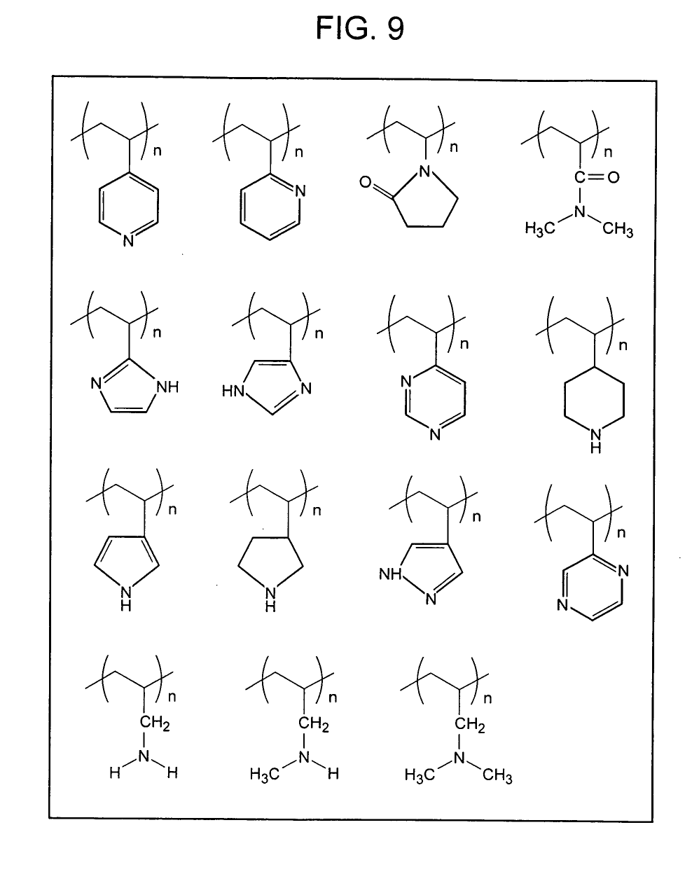

In addition the polymer of the substance having the basic group can be exemplified by the compounds shown in FIG. 9.

The amount of mixing of the polymer of the substance having the basic group is closely related to the number of the ion-dissociative groups. In practice, the ionic conductor can exhibit a distinctive effect when the derivative and the polymer of the substance having the basic group are mixed so as to adjust the ratio of the ion-dissociative group and the basic group (basic group/ion-dissociative group) to 20 or less on the molar basis, and preferably from 0.05 to 20.

The molar ratio exceeding 20 may result in decrease in density of the ion-dissociative group relative to the entire ionic conductor, or in a too large volume occupied by the polymer of the substance of having the basic group, and this may trigger adverse effects such as lowering in the conduction of ions such as protons, against expectation. On the contrary, the molar ratio less than 0.05 means that the number of basic group derived from the polymer of the substance becomes less than one-twentieth of the number of the ion-dissociative group, and that it becomes more difficult to keep insolubility of the ionic conductor to water or methanol through formation of the ion complex, so that the ionic conductor based on the present invention may fail in fully exhibiting the ion conductivity which is intrinsically owned by the ionic conductor based on the present invention.

In a method of manufacturing the ionic conductor of the present invention, a derivative in which an ion-dissociative group is bound to a carbonaceous substance composed of at least one species selected from the group consisting of fullerene molecule, cluster mainly composed of carbon, and structure of linear or tubular carbon; and a monomer of a substance having a basic group; are mixed, and the mixture is allowed to polymerize under heating. This makes it possible to manufacture the ionic conductor based on the present invention in which the derivative and the polymer of the substance form the ion complex.

In addition, another method of manufacturing the ionic conductor of the present invention includes a step of dissolving a derivative in which an ion-dissociative group is bound to a carbonaceous substance composed of at least one species selected from the group consisting of fullerene molecule, cluster mainly composed of carbon, and structure of linear or tubular carbon; and a polymer of a substance having a basic group; into a solvent to thereby prepare a homogeneous solution; and a step of removing the solvent.

In addition, another method of manufacturing the ionic conductor of the present invention includes a step of dissolving a derivative in which an ion-dissociative group is bound to a carbonaceous substance composed of at least one species selected from the group consisting of fullerene molecule, cluster mainly composed of carbon, and structure of linear or tubular carbon; and a polymer of a substance having a basic group; into respective solvents to thereby prepare respective homogeneous solutions; and a step of mixing these homogeneous solutions and recovering an insoluble matter.

The derivative alone is soluble to the solvent, but preparation of the homogeneous solution of the derivative and the polymer of the substance results in formation of the ion complex between the derivative and the polymer of the substance, which is insoluble to the solvent, so that the ionic conductor based on the present invention is obtained as the insoluble matter.

Examples of the solvent applicable herein include hydrocarbon solvents such as toluene, butane, pentane, hexane and cyclohexane; alcohols such as methanol, ethanol, 1-propanol and 2-propanol; phenols such as phenol and cresol; ethers such as diethyl ether, dioxane and tetrahydrofuran; ketones such as acetone and methyl ethyl ketone; nitrogen compounds and sulfur compounds such as acetonitrile, pyridine, N, N-dimethylformamide and dimethylsulfoxide; and inorganic solvents such as water.

The ionic conductor based on the present invention can directly be press-molded so as to obtain a desired geometry, such as pellet or film, or can be molded by filtration. No binder is necessary in these processes, and this is effective both in view of enhancing the conductivity of ions such as protons, and in view of achieving weight reduction of the ionic conductor. In particular, the polymer of the substance having the basic group also functions as a binder, and successfully adds a desirable film forming property and moldability. Of course, it is allowable to add the third component as the binder. Polymer materials applicable as the third component are not specifically limited so far as they do not inhibit the conduction of ions such as protons, and have film forming property. It is a general practice to use those having no electron conductivity, and having a good stability. Specific examples thereof include polyfluoroethylene and poly(vinylidene fluoride). The polymer binder as the third component can arbitrarily be mixed in the above-described process of manufacturing the ionic conductor based on the present invention.

In addition, besides the processes described in the above, it is also allowable to form a film composed of the ionic conductor based on the present invention, by first forming the polymer of the substance having the basic group in a film form, and then by immersing the film into a solution of the derivative to thereby dope the derivative into the polymer of the substance. It is further allowable to dope the derivative into the polymer of the substance, by allowing the solution of the derivative to permeate through the film of the polymer of the substance, to thereby form the film composed of the ionic conductor based on the present invention.

According to the ionic conductor and the method of fabricating the same based on the present invention, in which the derivative having the ion-dissociative group bound thereto and the polymer of the substance having the basic group are involved, it is made possible to obtain the ionic conductor insoluble to water, methanol solution and so forth, and is physically stable.

The ionic conductor can be used under a dry atmosphere or over a wide temperature range including normal temperature (approximately in a range from 160° C. to −40° C., for example), dense in the texture, and excellent in the gas blocking property. The ion dissociative is accelerated also under a dry atmosphere by virtue of the polymer of the substance having the basic group, and the dissociated ions can be smoothly migrate via the basic group, so that the ionic conductor exhibits a high ion conductivity.

In addition, the ionic conductor of the present invention is preferably applicable to various electrochemical devices. That is, in a basic structure comprising a negative electrode, a positive electrode, and a proton conductor held between these electrodes, the ionic conductor of the present invention is preferably applicable to the proton conductor.

More specifically, the ionic conductor based on the present invention is preferably applicable to an electrochemical device having the negative electrode and/or the positive electrode configured as gas electrodes, or to an electrochemical device having the negative electrode and/or the positive electrode configured as active substance electrodes.

Next paragraphs will describe an exemplary case in which the ionic conductor based on the present invention is applied to a fuel cell having the negative electrode supplied with a fuel and the positive electrode supplied with oxygen.

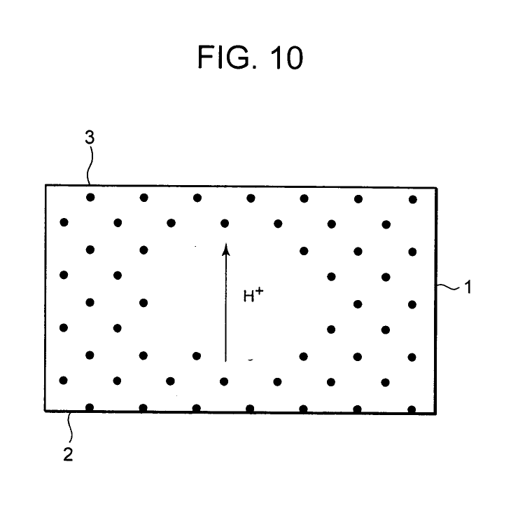

A mechanism of proton conduction in the fuel cell is as expressed by a schematic drawing shown in FIG. 10, wherein a proton conduction portion 1 is held between a negative electrode (hydrogen electrode, for example) 2 and a positive electrode (oxygen electrode, for example) 3, and a released proton (H+) migrates from the negative electrode 2 to the positive electrode 3, in the direction expressed by an arrow in the drawing.

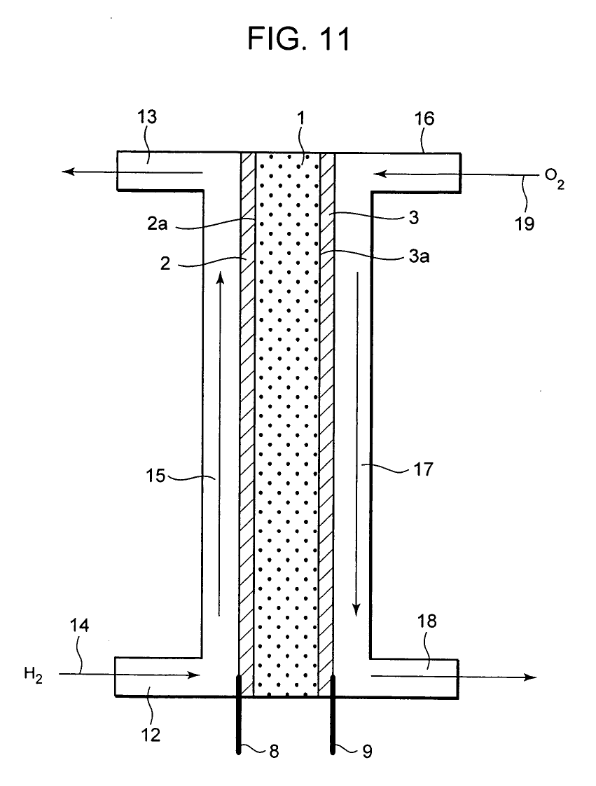

FIG. 11 shows a specific example of fuel cell case in which the ionic conductor based on the present invention is applied to the proton conduction portion. The fuel cell has the negative electrode (fuel electrode or hydrogen electrode) 2 and the positive electrode (oxygen electrode) 3 opposed to each other, having terminals 8 and 9 respectively attached thereto, and having catalysts 2a and 3a closely attached thereto or diffused thereinto, and the proton conduction portion 1 held therebetween. During the operation, hydrogen is supplied to an introduction port 12 on the negative electrode 2 side, and discharged through a discharge port 13 (occasionally not provided). A fuel (H₂) 14 generates protons as it passes through a passageway 15, the protons migrate, together with protons generated at the proton conduction portion 1, to the positive electrode side 3, react with oxygen (air) 19 supplied through an introduction port 16 into a passageway 17 and flow toward a disposal port 18, and thereby a desired electromotive force is extracted.

Thus-configured fuel cell, in which the ionic conductor based on the present invention is used for the proton conduction portion 1, can exhibit effects similarly to as described in the above.

### EXAMPLES

The following paragraphs will specifically explain the present invention on the basis of Examples.

### Example 1

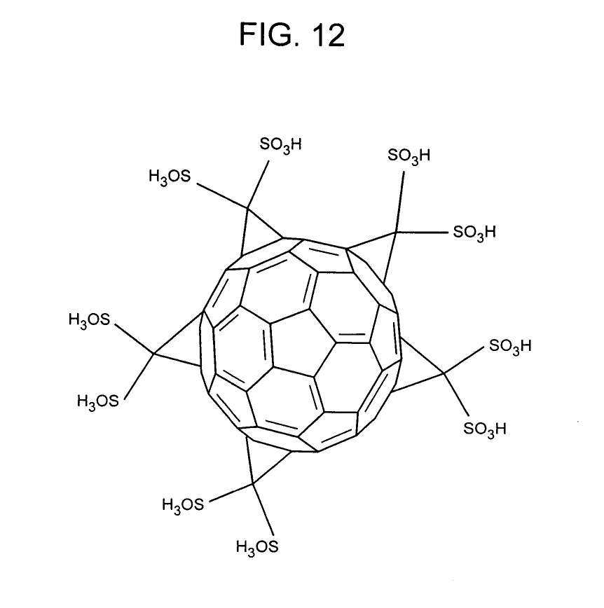

A sulfonic-acid-base fullerene derivative as shown in FIG. 12 was used as the derivative, and polyvinylimidazole shown in FIG. 8(p) was used as the polymer of the substance having the basic group. Polyvinylimidazole was manufactured based on a synthetic method described in Macromolec. Syn., 1974, 5, 43.

The sulfonic-acid-base fullerene derivative and polyvinylimidazole were respectively dissolved into methanol in a homogeneous manner, and two these solutions were mixed. Upon mixing, the ion complex is formed between the sulfonic-acid-base fullerene derivative and polyvinylimidazole, which is insoluble to methanol, and thereby a precipitate produces. The ionic conductor based on the present invention, obtained by recovering the precipitate and dried in vacuo at 40° C. for 12 hours, was immersed in water or methanol solution, and proved to be insoluble even one week after.

The ionic conductor obtained as described in the above was unidirectionally pressed so as to obtain a round pellet of 4 mm in diameter. The powder was consequently proved as excellent in the moldability despite it does not contain, for example, any binder resin at all, and was to be pelletized easily.

Using the molded pellet, the conductivity was measured by the AC impedance method. In the measurement, the pellet fabricated as described in the above was held on both surfaces between 4-mm-diameter gold plates, through which AC voltage ranging from 10 MHz to 1 Hz was applied (amplitude 100 mV), and complex impedance was measured at the individual frequencies. It is noted that the measurement was carried out in two ways such as under a dry atmosphere and under a moist atmosphere.

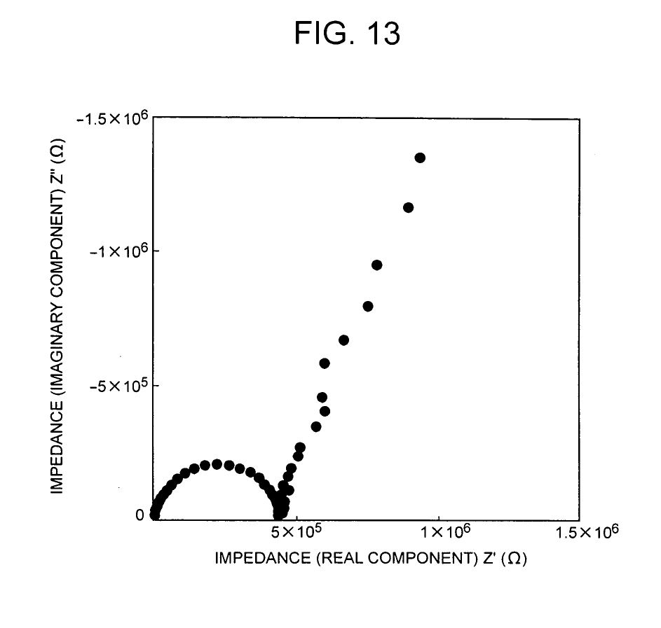

FIG. 13 shows the Cole-Cole plot of a sample based on a ratio of mixing of sulfonic-acid-base fullerene derivative:polyvinylimidazole=6:1, measured at 25° C.

As is clear from FIG. 13, a single very well-shaped semicircle can be observed. This indicates that a certain kind of conduction behavior of charged particles resides in the pellet. A sharp increase in the imaginary component of impedance was observed in the lower frequencies. This indicates blocking of the charged particles between the gold electrodes and the pellet occurs as the voltage gradually becomes more DC-like. Of course, the charged particles on the gold electrode side are electrons, so that the charged particles in the pellet are neither electrons nor holes, and are obviously other type of charged particles, or ions (protons).

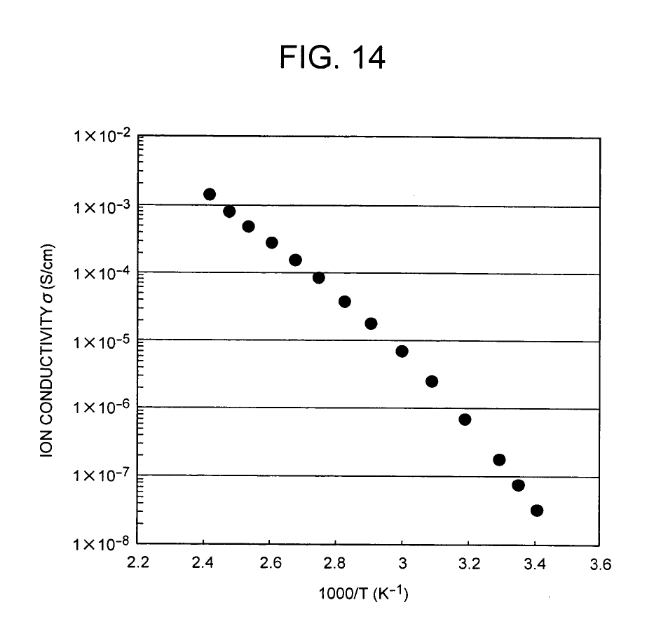

The ion conductivity can be determined on the basis of the intercept of the arc on the x-axis on the higher frequency side of the Cole-Cole plot in FIG. 13. Temperature dependence of the ion conductivity is shown in FIG. 14. As is clear from FIG. 14, the ionic conductor based on the present invention showed large ion conductivity over a wide temperature range even in the dry atmosphere, showing an increase as the temperature elevated.

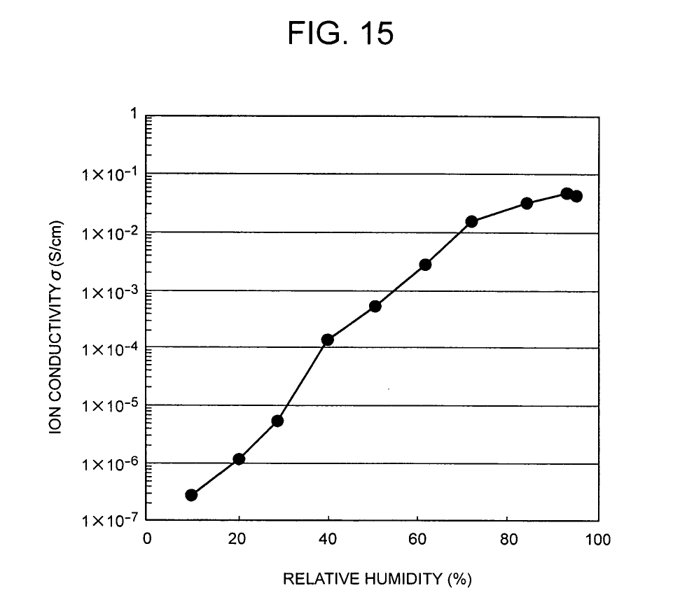

Next, a sample based on a ratio of mixing of sulfonic-acid-base fullerene derivative:polyvinylimidazole=4:1 was subjected to measurement of the conductivity by the AC impedance method, to thereby measure humidity dependence of the conductivity. More specifically, the fabricated pellet was held on both surfaces between 4-mm-diameter gold plates, placed in a constant-temperature & constant-humidity bath conditioned at 25° C., applied with AC voltage ranging from 10 MHz to 1 Hz (amplitude 100 mV), and complex impedance was measured at the individual frequencies. The complex impedance varied with time and reached almost plateau 3 hours and thereafter, so that the humidity was varied, measurement was made again 4 hours after, and the ion conductivity was determined based on the intercept of the arc on the x-axis on the higher frequency side of the Cole-Cole plot. Results were shown in FIG. 15. As is clear from FIG. 15, the ion conductivity elevated with increase in the humidity, showing an ion conductivity of as high as 4.5×10⁻² (S/cm) at 95% relative humidity.

### Example 2

Vinylimidazole (VIm) and fullerene metaphosphate (MPF), which are the monomers, were mixed, and a trail was made on polymerizing them under heating. The trial of polymerization was carried out without specially adding any solvent or initiator, based on the two reasons that VIm has a melting point of approximately 82° C. and can exist in a liquid form of monomer under high temperatures, and that the phosphoric acid groups can serve as an initiator for the cation polymerization. Mixtures were prepared so as to attain ratios of VIm and phosphoric acid group of 3:1 and 9:1, and were kept at 100° C. for 16 hours. It was visually confirmed that melting of VIm resulted in a uniform mixing. Sixteen hours after, the mixture was allowed to cool to room temperature. It was confirmed that thus-obtained solid added with water gradually dissolved into the water, proving that the mixture was made less soluble to a considerable degree as compared with MPF in a single form, although not being completely insolubilized.

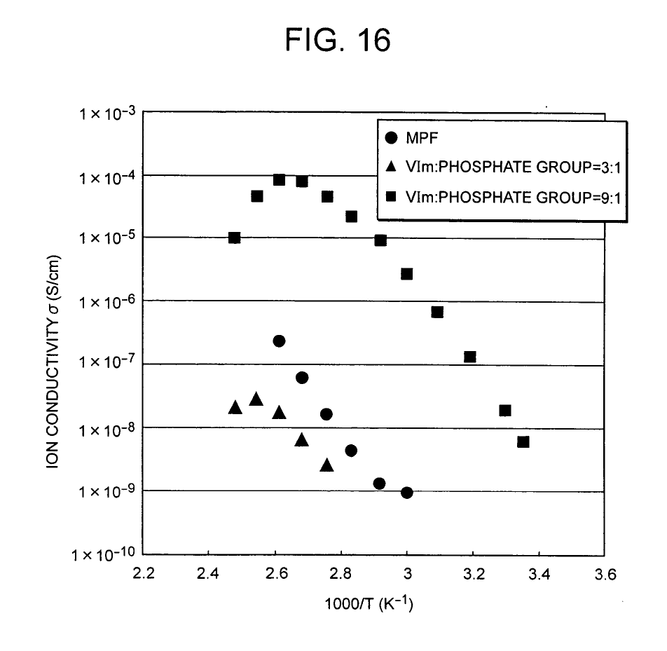

The ionic conductor based on the present invention, obtained as described in the above, was subjected to measurement of the ion conductivity under room temperature in a dry atmosphere. Results are shown in FIG. 16. As is clear from FIG. 16, the ionic conductor having a ratio of VIm:phosphate group=3:1 showed decrease in the ion conductivity as compared with MPF in a single form, whereas a ratio of 9:1 resulted in increase. These results are probably ascribable to difference in the amount of residual unreacted monomer after the polymerization. A larger residual content of the unreacted monomer is supposed to give larger ion conductivity. It was also found that the insolubilization further proceeded when the polymerization temperature was raised to 150° C.

As is obvious from Example 1 and Example 2, because the ionic conductor based on the present invention was configured as containing the ion complex formed between the fullerene derivative as the derivative having the ion-dissociative group and the polymerized compound of the substance having the basic group together form the ion complex, it was made possible to insolubilize the fullerene derivative which has previously been soluble to water and methanol solution, and to exhibit a desirable proton conduction even under lowered room temperature and in a dried state. Use of an io conductor based on the present invention as a proton exchange film makes it possible to realize a device, such as fuel cell, which is physically stable by virtue of insolubility thereof to water or methanol solution, and allows start-up under dryness.

The present invention has been described referring to the embodiments and Examples, wherein the above-described examples can be modified in various ways based on the technical spirit of the present invention.

For example, although the above explanation was made on the case where the derivative bound with the ion-dissociative group and the polymer of the substance having the basic group were mixed, it is also allowable that the ionic conductor based on the present invention is configured as containing the carbonaceous substance composed of at least one species selected from the group consisting of the fullerene molecule, the cluster mainly composed of carbon, and the structure of linear or tubular carbon; and the ion-dissociative group and the basic group bound thereto.

In addition, in the electrochemical device, such as the fuel cell, based on the present invention, the shape, configuration, materials and so forth may arbitrarily be selected without departing from the scope of the present invention.

The ionic conductor based on the present invention can further be adopted to ion conduction of lithium ions, besides the above-described protons (H⁺), and is applicable to alkali secondary battery, for example.

1-26. (canceled)

27. An ionic conductor having:
a derivative in which an ion-dissociative group is bound to a carbonaceous substance composed of at least one species selected from the group consisting of fullerene molecule, cluster mainly composed of carbon, and structure of linear or tubular carbon; and
a polymer of a substance having a basic group.

28. The ionic conductor as claimed in claim 27, wherein said derivative comprises a chemical or physical, coupled or crosslinked product of said carbonaceous substances.

29. The ionic conductor as claimed in claim 27, in which said derivative bound with said ion-dissociative group and the polymer of said substance having said basic group are mixed.

30. The ionic conductor as claimed in claim 27, wherein at least one of said ion-dissociative group is an acidic functional group.

31. The ionic conductor as claimed in claim 27, wherein a ratio of said ion-dissociative group and said basic group is 20 or less on the molar basis.

32. The ionic conductor as claimed in claim 27, wherein said ion-dissociative group is at least one species selected from the group consisting of —SO₃M, —PO(OM)₂, —SO₂NMSO₂—, —SO₂NM₂, —COOM, ═CPO(OM)₂ and ═C(SO₃M)₂, where, M is a cation producible group.

33. The ionic conductor as claimed in claim 27, wherein at least a functional group having said ion-dissociative group is bound to said carbonaceous substance, said functional group being at least one species selected from the group consisting of -A-SO₃M, -A-PO(OM)₂, -A-SO₂NMSO₂—R⁰, -A-SO₂NM₂ and A-COOM, where A represents —O—, —R—, —O—R—, —R—O—, —O—R—O— or —R—O—R′—, where R and R′ are any one of alkyl component and fluoroalkyl component respectively expressed by CxHy and CxFyHz (1≦x≦20, 1≦y≦40, 0≦z≦39), and where M represents a cation producing group, and R⁰ represents —CF₃ or —CH₃.

34. The ionic conductor as claimed in claim 27, wherein the polymer of said substance having said basic group is a polymer of a compound containing at least any one of a nitrogen atom, an oxygen atom and a sulfur atom.

35. The ionic conductor as claimed in claim 27, wherein the polymer of said substance contains at least any one of structural components expressed by a structural formula as follows:

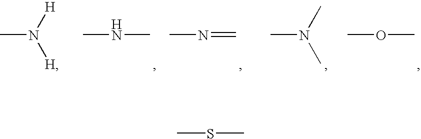

36. The ionic conductor as claimed in claim 27, wherein said basic portion of the polymer of said substance is at least any one species selected from the group consisting of amino group, pyrrolidone group, pyridine group, imidazole group, pyrimidine group, piperazine group, pyrrole group, pyrrolidine group, pyrazole group, benzimidazole group, phenylimidazole group and pyrazine group.

37. The ionic conductor as claimed in claim 34, wherein a polymer of said compound containing the nitrogen atom is a polymer of a heterocyclic compound.

38. The ionic conductor as claimed in claim 35, wherein the polymer of said compound having said basic group is at least any one species selected from the group consisting of polymers having a structure of imidazole, pyrrole, pyrrolidine, pyridine, pyrazole, benzimidazole, phenylimidazole, vinylimidazole, pyrazine, piperazine, oxazole, isooxazole, thiazole, isothiazole, furan, thiophene, and derivatives thereof.

39. A method of manufacturing an ionic conductor, the method comprising:
dissolving a derivative in which an ion-dissociative group is bound to a carbonaceous substance composed of:
at least one species selected from the group consisting of:
fullerene molecule;
cluster mainly composed of carbon; and
structure of linear or tubular carbon; and
a polymer of a substance having a basic group, into a solvent to thereby prepare a homogeneous solution; and
removing said solvent.

40. A method of manufacturing an ionic conductor, the method comprising:
dissolving a derivative in which an ion-dissociative group is bound to a carbonaceous substance composed of:
at least one species selected from the group consisting of:
fullerene molecule;
cluster mainly composed of carbon; and
structure of linear or tubular carbon; and
a polymer of a substance having a basic group, into respective solvents to thereby prepare respective homogeneous solutions; and
mixing these homogeneous solutions and recovering an insoluble component.

41. A method of manufacturing an ionic conductor, comprising:
mixing a derivative in which an ion-dissociative group is bound to a carbonaceous substance composed of:
at least one species selected from the group consisting of:
fullerene molecule;
cluster mainly composed of carbon; and
structure of linear or tubular carbon; and
a monomer of a substance having a basic group; and
allowing said mixture to polymerize to thereby manufacture an ionic conductor having said derivative and the polymer of said substance having said basic group.

42. The method of manufacturing an ionic conductor as claimed in any one of claims 39, 40 and 41, wherein a molar ratio of said ion-dissociative group and said basic group is adjusted to 20 or less.

43. The method of manufacturing an ionic conductor as claimed in any one of claims 39, 40 and 41, using, as said ion-dissociative group, at least any one species selected from the group consisting of —SO₃M, —PO(OM)₂, —SO₂NMSO₂—, —SO₂NM₂, —COOM, ═CPO(OM)₂ and ═C(SO₃M)₂ where, M represents a cation producing group.

44. The method of manufacturing an ionic conductor as claimed in any one of claims 39, 40 and 41, using, as said derivative, said carbonaceous substance bound with a functional group having at least said ion-dissociative group, said functional group being at least one species selected from the group consisting of -A-SO₃M, -A-PO(OM)₂, -A-SO₂NMSO₂—R⁰, -A-SO₂NM₂ and A-COOM, where, A represents —O—, —R—, —O—R—, —R—O—, —O—R—O— or —R—O—R′—, where R and R′ are any one of alkyl component and fluoroalkyl component respectively expressed by CxHy and CxFyHz (1≦x≦20, 1≦y≦40, 0≦z<39), and where M represents a cation producing group, and R⁰ represents —CF₃ or —CH₃.

45. The method of manufacturing an ionic conductor as claimed in any one of claims 39, 40 and 41, wherein the polymer of said substance having said basic group is a polymer of a compound containing at least any one of a nitrogen atom, an oxygen atom and a sulfur atom.

46. The method of manufacturing an ionic conductor as claimed in any one of claims 39, 40 and 41, wherein the polymer of said substance contains at least any one of structural components expressed by a structural formulae as follows:

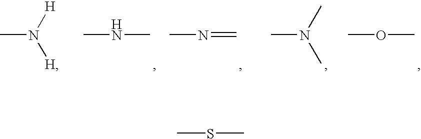

47. The method of manufacturing an ionic conductor as claimed in any one of claims 39, 40 and 41, using, as said basic portion of the polymer of said substance, at least any one species selected from the group consisting of amino group, pyrrolidone group, pyridine group, imidazole group, pyrimidine group, piperazine group, pyrrole group, pyrrolidine group, pyrazole group, benzimidazole group, phenylimidazole group and pyrazine group.

48. The method of manufacturing an ionic conductor as claimed in claim 45, wherein a polymer of said compound containing the nitrogen atom is a polymer of a heterocyclic compound.

49. The method of manufacturing an ionic conductor as claimed in claim 46, wherein the polymer of said compound having said basic group is at least any one species selected from the group consisting of polymers having a structure of imidazole, pyrrole, pyrrolidine, pyridine, pyrazole, benzimidazole, phenylimidazole, vinylimidazole, pyrazine, piperazine, oxazole, isooxazole, thiazole, isothiazole, furan, thiophene, and derivatives of them.

50. An electrochemical device comprising a negative electrode, a positive electrode, and an ionic conductor held therebetween, said ionic conductor having a derivative in which an ion-dissociative group is bound to a carbonaceous substance composed of at least one species selected from the group consisting of fullerene molecule, cluster mainly composed of carbon, and structure of linear or cylindrical carbon; and a polymer of a substance having a basic group.

51. The electrochemical device as claimed in claim 50, wherein said ionic conductor is the ionic conductor described in any one of claims 28 to 38.

52. The electrochemical device as claimed in claim 50, being configured as a fuel cell.
